(19) United States
(12) Patent Application Publication
(10) Pub. No.: US 2010/0162502 A1
(43) Pub. Date: Jul. 1, 2010

(54) Fluid Flow Adjustment Lockout

(76) Inventor: Sean K. Goff, Bristol, WI (US)

Correspondence Address: QUARLES & BRADY LLP, 411 E. WISCONSIN AVENUE, SUITE 2040, MILWAUKEE, WI, 53202-4497, US

(21) Appl. No.: 12/344,874

(22) Filed: Dec. 29, 2008

(51) Int. Cl. A47L 11/00; B08B 3/04

(52) U.S. Cl. 15/52; 134/115 R

(57) ABSTRACT

A fluid flow lockout mechanism for a floor maintenance machine is disclosed that improves operator efficiency and conserves water. The fluid flow lockout mechanism includes a fluid flow adjustment control selectively operably connected to a fluid flow control mechanism that controls the flow of fluid from a reservoir to an outlet. The fluid lockout mechanism further includes a fluid flow lockout switch having a first state in which the fluid flow adjustment control is operably connected to the fluid flow control mechanism and a second state in which the fluid flow adjustment control is not operably connected to the fluid flow control mechanism.

### CROSS-REFERENCE TO RELATED APPLICATION

Not applicable.

### STATEMENT OF FEDERALLY SPONSORED RESEARCH OR DEVELOPMENT

Not applicable.

### BACKGROUND OF THE INVENTION

This invention relates to floor scrubbers. In particular, this invention relates to a fluid flow lockout mechanism for a floor scrubber.

Floor scrubbers provide an industrial strength means of cleaning dirty floor surfaces. During operation, an operator directs a floor scrubber over the surface of the floor to be cleaned. Cleaning fluid is applied to the floor and large rotatable disk brushes are swept over the floor to mechanically loosen debris or other contaminants. The loose debris then is collected using cylindrical brushes that lift the debris from the floor and deposit it into a collection chamber.

The operator controls various aspects of the operation of the floor scrubber. Some of the items that the operator has control over include, for example, the direction of propulsion of the floor scrubber, the speed of the floor scrubber, the force exerted by the brushes on the floor, the amount of cleaning fluid dispensed onto the floor, and the like.

A common problem is that workers intentionally set the rate at which cleaning fluid is dispensed on the floor to be too high. For many workers, the fact that the floor scrubber needs to be stopped for a fluid refill is also a good excuse to take a break. This reduces efficiency as it takes longer and ultimately costs more to clean the floor.

Further, setting the flow rate too high wastes water. In many regions, water is a scare resource and the overuse of water is to be avoided.

Hence, a need exists for floor scrubber that is operated more efficiently and does a better job of conserving water.

### SUMMARY OF THE INVENTION

A floor scrubber having a fluid flow lockout mechanism is disclosed that selectively prevents an operator from adjusting the rate at which fluid flows from a reservoir to an outlet. The fluid flow lockout mechanism includes a fluid flow adjustment control and a fluid flow lockout switch that controls the flow of a fluid from a reservoir to an outlet. The fluid flow lockout switch is turned on or off to selectively operably connect the fluid flow adjustment control to a fluid flow control mechanism. When the fluid flow adjustment control is operably connected to the fluid flow control mechanism, then the fluid flow adjustment control can be manipulated by a user to limit the flow of fluid dispensed from the outlet. When the fluid flow adjustment control is not operatively connected to the fluid flow control mechanism, then the operator will be unable to make adjustments to the fluid flow from the outlets using the fluid flow adjustment control.

This fluid flow lockout mechanism provides a manager with the ability to prevent an operator of the floor scrubber from altering the flow of the fluid. In this way, adjustments to the operational conditions of the vehicle can be made as necessary by a manager, but the operator will not be able to unilaterally adjust the fluid flow. This reduces the risk of the operator wasting cleaning fluid or water. Further, this results in more efficient operation of the floor scrubber, as there is less downtime due to refilling the reservoir and taking breaks.

The fluid flow adjustment lockout can function independently of the other controls (i.e., the power switch, steering, and the like). In this way, the operator can generally control the operation of the floor scrubber. However, if there is a condition in which a legitimate adjustment needs to be made to the fluid flow, but in which the fluid flow adjustment control has been locked out by a manager, then the operator can still completely stop the operation of the floor scrubber until a manager or other supervisor unlocks the fluid flow adjustment control to make the required adjustments.

These and still other advantages of the invention will be apparent from the detailed description and drawings. What follows is merely a description of a preferred embodiment of the present invention. To assess the full scope of the invention the claims should be looked to as this preferred embodiment is not intended to be the only embodiment within the scope of the claims.

### BRIEF DESCRIPTION OF THE DRAWINGS

FIG. 1 is a perspective view of a walk-behind floor scrubber;

FIG. 2 is a perspective view of a control unit incorporating the fluid flow lockout mechanism for a walk-behind floor scrubber;

FIG. 3 is a side view of the control unit of FIG. 2; and

FIG. 4 is a block diagram illustrating the fluid flow lockout mechanism.

### DETAILED DESCRIPTION OF THE PREFERRED EMBODIMENT

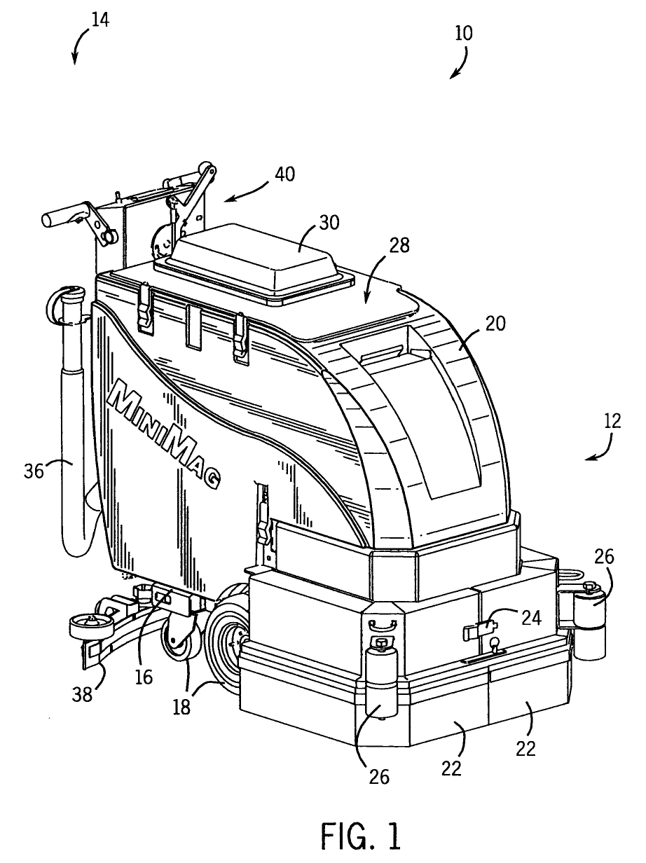

Referring first to FIG. 1, a floor scrubber 10 is shown for the cleaning of floors. The floor scrubber 10 is a walk-behind floor scrubber, such as the Mini Mag manufactured by R.P.S. Corporation of Racine, Wis. However, the floor scrubber 10 could be any kind of floor scrubber 10 including both walk-behind or riding-type floor scrubbers.

In the form shown, the floor scrubber 10 has a front end 12 and a rear end 14 behind which an operator may stand. A chassis 16 extends between the front end 12 and the rear end 14. The chassis 16 has a set of wheels 18 mounted on the bottom side thereof for contact with the floor. The body of the chassis 16 is largely covered by a liftable hood 20. The liftable hood 20 covers a number of the internal components of the floor scrubber 10 (e.g., the battery).

At the front end 12 of the floor scrubber 10 and near the bottom of the liftable hood 20, a pair of jaws 22 partially surround a pair of motor driven rotary brushes (not shown) for scrubbing the floor. The pair of jaws 22 can hingedly swing outward to expose the rotary brushes for maintenance or repair. The pair of jaws 22 are held closed by a latch 24 and each include a set of bumpers 26 that prevent damage should the floor scrubber 10 bump into a stationary object.

The liftable hood 20 has a reservoir 28 formed therein. A removable cover 30 is placed over the reservoir 28 and, when lifted, provides access to the reservoir 28. The reservoir 28 serves as a tank for holding the cleaning fluid, such as water or a soapy fluid. The reservoir 28 can also serve as a recovery tank that is used to hold the cleaning fluid after it has been used and recovered using a vacuum system or the like.

Although the reservoir 28 is shown as being formed in part of the liftable hood 20. The reservoir 28 could be separately formed and/or placed in an alternate location on the floor scrubber 10.

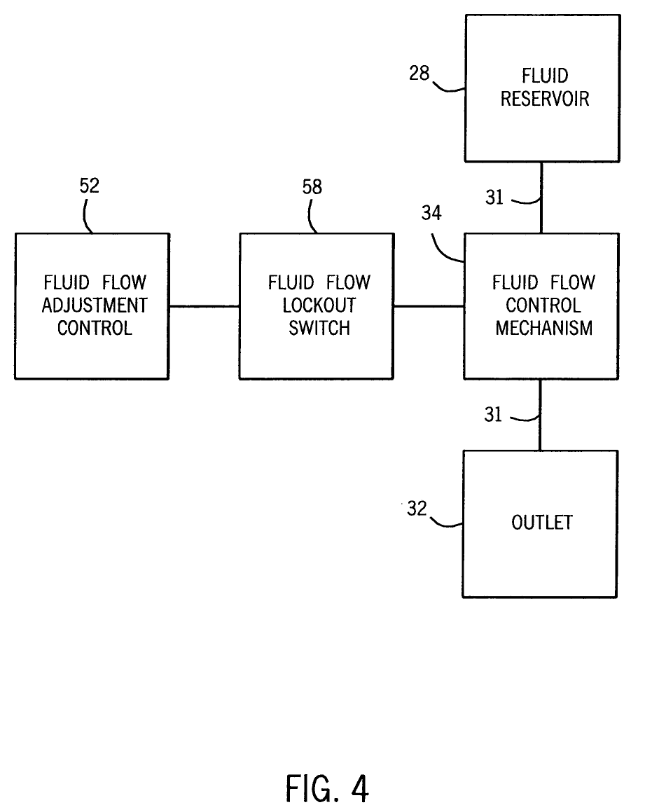

Although it cannot be seen in FIG. 1, but as illustrated in the block diagram of FIG. 4, the reservoir 28 includes a fluid passageway 31 that extends to an outlet 32. The outlet 32 is placed proximate the rotary brushes such that the outlet 32 can dispense cleaning fluid from the reservoir 28 to the floor or rotary brushes during operation of the floor scrubber 10. As will be described in more detail below, a fluid flow control mechanism 34 is placed between the reservoir 28 and the outlet 32 to control the rate at which fluid flows through the fluid passageway 31.

Referring back to FIG. 1, the floor scrubber 10 additionally includes a number of other optional parts. A drain hose 36 is connected to the side of the floor scrubber 10 and can be lowered to drain the reservoir 28. A squeegee 38 extends across the rear end 14 of the floor scrubber 10 to contain and direct any cleaning fluid applied to the floor. In some forms of the floor scrubber 10, a vacuum system may be mounted to or proximate to the squeegee 38 to collect excess fluid.

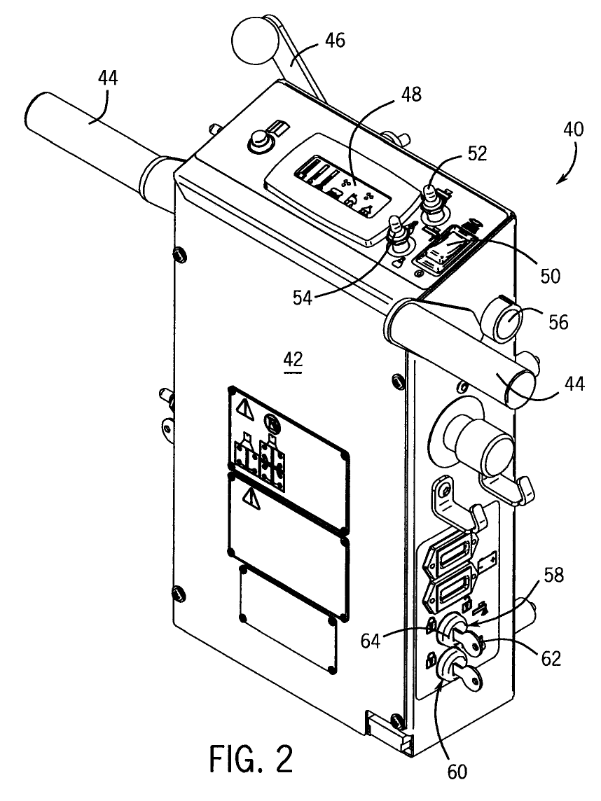

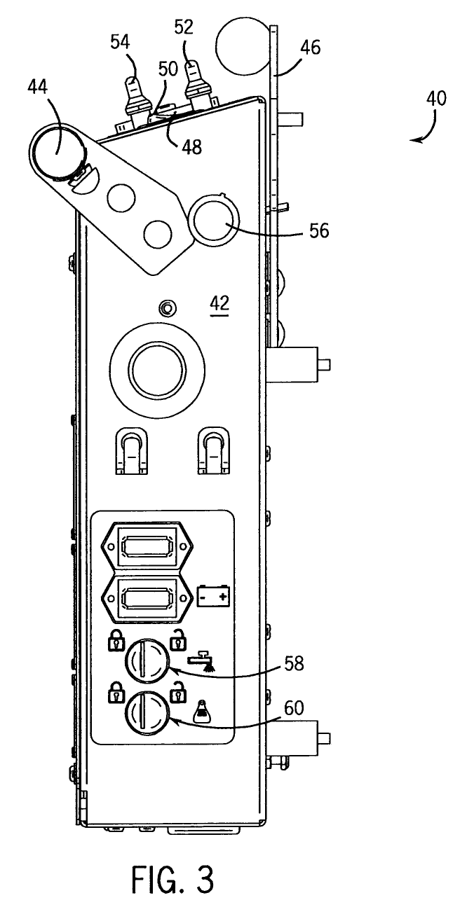

A control unit 40 is mounted on the chassis 16 proximate the rear end 14 of the floor scrubber 10. Referring now to FIGS. 2 and 3, the control unit 40 can be seen in detail. The control unit 40 includes a housing 42 supporting a number of controls. These controls include a set of adjustable handlebars 44 and a lift lever 46 for raising or lowering the squeegee 38. A number of controls are also placed around a liquid crystal display (LCD) display panel 48. These controls include a power switch 50, a cleaning fluid flow toggle 52, and a down pressure toggle 54. Other controls are located on the side of the control unit 40 including a speed control dial 56 and a down pressure lockout 60 that is used to prevent the brush down pressure from damaging the floor. In the form shown, the LCD display panel 48 is electrically connected to the various controls to display settings related to the controls (i.e., the cleaning fluid flow rate and the like).

On the side of the control unit 40 there is a cleaning fluid flow manager lockout 58. The cleaning fluid flow manager lockout 58 is key-operated, meaning that its operation requires that a key 62 be inserted and rotated within a lock 64 of the cleaning fluid flow manager lockout 58 to switch the cleaning fluid flow manager lockout 58 from a locked state to an unlocked state or vise versa.

Referring now to FIG. 4, the connectivity of the fluid flow lockout mechanism for the floor scrubber 10 is shown. As stated above, the reservoir 28 has a fluid passageway 31 extending to an outlet 32 that dispenses the fluid. Along the fluid passageway 31, and between the reservoir 28 and the outlet 32, there is a fluid flow control mechanism 34. The fluid flow control mechanism 34 could be an adjustable valve or the like that can be used to restrict the flow of a fluid through the fluid passageway 31 between the reservoir 28 and the outlet 32. A fluid flow adjustment control, such as the cleaning fluid flow toggle 52,, is selectively operably connected to the fluid flow control mechanism 34. A fluid flow lockout switch, such as the cleaning fluid flow manager lockout 58, is placed between the fluid flow adjustment control and the fluid flow control mechanism 34.

The fluid flow lockout switch is alterable between a locked and an unlocked state. In the unlocked state, the fluid flow adjustment control is operably connected with the fluid flow control mechanism 34 (i.e., the adjustment of the cleaning fluid flow toggle 52 will alter the flow rate of the fluid between the reservoir 28 and the outlet 32 by the adjustment of the fluid flow control mechanism 34). In the locked state, the fluid flow adjustment control is not operably connected with the fluid flow control mechanism 34 (i.e., any attempt to adjust the fluid flow control mechanism 34 using the cleaning fluid flow toggle 52 will fail).

In the form shown, the cleaning fluid flow manager lockout 58 acts as the fluid flow lockout switch and includes a key 62 and a lock 64 in which turning the key 62 within the lock 64 toggles between the locked and unlocked states to disable or enable the fluid flow adjustment control. During manager adjustment, the manager inserts the key 62 into the lock 64 and turns the key 62 to unlock or enable the fluid flow adjustment control. When the adjustment is complete, the manager turns the key 62 back to the position in which the fluid flow lockout switch is in a locked state or disabled and removes the key 62 so that no further adjustments can be made.

Other types of fluid flow lockout switches could also be used. For example, a keypad that requires entry of a pass code could be used as a switch. Alternatively, a swipe card or a key card could be inserted into a slot or slid past a card reader. Moreover, any type of locking device, mechanical, electrical, or otherwise are contemplated as being potentially suitable for inclusion in the fluid flow lockout switch.

Although the fluid flow adjustment control is shown as the cleaning fluid flow toggle 52 in which the cleaning fluid flow toggle 52 can be switched upward relative to a neutral position to increase the fluid flow and switched downward relative to a neutral position to decrease the fluid flow, other types of fluid flow adjustment controls could be used. The fluid flow adjustment control could include any electrical, mechanical, or electromechanical adjustment controls such as knobs, levers, buttons, and the like.

It should also be appreciated that other variations to the lockout are contemplated. In some forms, the manager lockout may be used to set fluid flow adjustment limits (i.e., maximum and minimum allowable flow rates) within which the operator can make adjustments. In order to alter the fluid flow adjustment limits, the manager would need to disable a lock on the limit adjustment. Once the adjustments to the fluid flow limits were made, the manager would again lockout the control over the limit adjustment. Now the operator could alter the fluid flow, but only within the limits set by the manager.

Thus, the present invention provides a fluid flow lockout mechanism that prevents an operator from adjusting the rate of fluid flow in a floor scrubber or other floor maintenance machine. This fluid flow lockout mechanism has a locked state in which the operator cannot use the fluid flow adjustment control and an unlocked state in which a manager, or another authorized person, can use the fluid flow adjustment control to change the fluid flow of the floor scrubber.

By selectively locking out the fluid flow adjustment control, over- or under-application or cleaning fluid or other fluids can be prevented. This eliminates the possibility that the fluid flow adjustment control will be increased by the operator in an attempt to require more refills and thus to take more breaks. In addition to improving operator efficiency, the fluid flow adjustment control also conserves water, since the cleaning fluid can be prevented from being excessively dispensed by the floor cleaner.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A floor maintenance machine comprising:
a chassis;
a control unit linked to the chassis, the control unit including a set of controls for operating the floor scrubber;
at least one floor engaging implement linked to the chassis;
a reservoir for holding a fluid, the reservoir being in fluid communication with an outlet proximate the at least one floor engaging implement; and
a fluid flow lockout mechanism including:
a fluid flow adjustment control selectively operably connected to a fluid flow control mechanism that controls the flow of fluid from the reservoir to the outlet, the fluid flow adjustment control being located on the control unit; and
a fluid flow lockout switch having a first state in which the fluid flow adjustment control is operably connected to the fluid flow control mechanism and a second state in which the fluid flow adjustment control is not operably connected to the fluid flow control mechanism.

2. The floor maintenance machine as in claim 1, wherein the fluid flow lockout switch includes a key and a lock.

3. The floor maintenance machine as in claim 2, wherein the key is removable from the lock.

4. The floor maintenance machine as in claim 1, wherein the fluid flow lockout mechanism operates independently of any other functions of the floor scrubber.

5. The floor maintenance machine as in claim 1, wherein the fluid flow lockout mechanism operates independently of a power function of the floor sweeper.

6. The floor maintenance machine as in claim 1, wherein the fluid flow adjustment control is a fluid flow toggle switch.

7. The floor maintenance machine as in claim 6, wherein the fluid flow toggle switch is movable between a neutral position, an increase position, and a decrease position and wherein a fluid flow level selected by the fluid flow toggle is shown on a display panel.

8. The floor maintenance machine as in claim 7, wherein the display panel is a liquid crystal display.

9. The floor maintenance machine of claim 1, wherein the at least one floor engaging implement includes a disk brush.

10. The floor maintenance machine of claim 1, wherein the floor maintenance machine is a floor scrubber.
